(19) United States
(12) Patent Application Publication
(10) Pub. No.: US 2026/0067684 A1
(43) Pub. Date: Mar. 5, 2026

(54) PAIRING METHOD IN A SYSTEM FOR AUTOMATED MANAGEMENT OF SMART METERS

(71) Applicant: SAGEMCOM ENERGY & TELECOM SAS, Bois-Colombes (FR)

(72) Inventors: Henri TEBOULLE, Bois-Colombes (FR); Jean-Paul LECAPPON, Bois-Colombes (FR)

(73) Assignee: SAGEMCOM ENERGY & TELECOM SAS, Bois-Colombes (FR)

(21) Appl. No.: 19/295,179

(22) Filed: Aug. 8, 2025

(30) Foreign Application Priority Data
Aug. 27, 2024 (FR) 2409156

(51) Int. Cl. H04W 12/0431; G01D 4/00; H04W 12/03; H04W 76/10

(52) U.S. Cl. CPC H04W 12/0431; G01D 4/002; H04W 12/03; H04W 76/10

(57) ABSTRACT

For pairing an orphan smart meter with a relevant information system intended to remotely manage smart meters in an automated-management system including a plurality of candidate information systems, the orphan smart meter sends to a multi-utility gateway a pairing request that includes information in clear on the type of smart meter. The multi-utility gateway finds, among the candidate information systems, those that remotely manage smart meters of the same type as the one indicated in the pairing request and relays the pairing request accordingly. The relevant information system sends in response a positive acknowledgement including information in clear for the multi-utility gateway and encrypted information for the orphan smart meter.

### TECHNICAL FIELD

At least one embodiment relates to a pairing method in a system for automated management of smart meters, such as electricity consumption meters, water consumption meters, gas consumption meters, etc.

### PRIOR ART

Smart meters are known, of the energy meter type (electricity meters, heat meters, etc) or fluid meters (fluid-consumption meters: water, gas, etc), which comprise communication interfaces enabling an automated-management system to implement a remote collection of consumption data. Consumption data can thus be transmitted, at regular intervals or on demand, to an information system IS processing them in a centralised manner.

Various information systems IS can share one and the same network infrastructure, and each subscriber can take out subscriptions with different distributors (suppliers), who can manage smart meters of the same type (e.g. smart water meters) or of various types (e.g. smart water meters and smart gas meters). However, when a subscription is taken out, it can be tedious to pair the smart meter in question with the correct information system IS suitable for managing it in accordance with the subscription taken out.

It is therefore desirable to provide a solution that makes it possible to effectively and securely pair the smart meters with their relevant information systems IS. It is therefore desirable to provide a solution that makes it possible to thus pair smart meters of a block of flats or of a residential unit with their relevant information systems IS, while limiting the deployment costs (and resources).

### DISCLOSURE OF THE INVENTION

For this purpose, a pairing method is proposed for pairing a smart meter, referred to as an orphan smart meter, with an information system, referred to as the relevant information system, which is intended to remotely manage a subset of smart meters that are registered with said relevant information system, the pairing method being implemented by a multi-utility gateway in an automated-management system comprising a plurality of candidate information systems sharing one and the same network infrastructure for remotely managing respective subsets of smart meters, the method comprising:
receiving a pairing request coming from the orphan smart meter, which includes information on the type of smart meter, in clear, and smart-meter identifier information that is in a form encrypted by means of a first symmetric key K_DSO known to the orphan smart meter and to the relevant information system;
finding, among the candidate information systems, those that remotely manage smart meters of the same type as the one indicated in the pairing request;
sending, by means of a secure protocol via the network infrastructure, to the candidate information systems found, a relayed pairing request that includes said smart-meter identifier information in encrypted form as presented in the pairing request received;
receiving, by means of the secure protocol via the network infrastructure, in response to the relayed pairing request, a positive acknowledgement including identifier information on the relevant information system in a form encrypted by means of said first symmetric key K_DSO, a second symmetric key K_WM specific to the orphan smart meter in clear and the same second symmetric key K_WM in a form encrypted by means of a third symmetric key MK_DSO known to the orphan smart meter and to the relevant information system;
transmitting to the orphan smart meter a pairing-acceptance message that includes the identifier information on the relevant information system in encrypted form and the second symmetric key K_WM in encrypted form, as presented in the positive acknowledgement received; and
acting as intermediary between the orphan smart meter then paired and the relevant information system during subsequent exchanges, using the symmetric key K_WM for communicating with the orphan smart meter then paired.

Thus, by means of the information on the type of smart meter in the pairing request, the multi-utility gateway is capable of determining which information systems to address among the candidate information systems. The smart-meter identifier being encrypted in the pairing request, this information is protected and an information system (or any other device) that does not have available the appropriate symmetric key K_DSO will not be in a position to decrypt it. The same applies to the identifier information on the relevant information system when it is returned by said relevant information system. The symmetric key K_WM to be used subsequently between the multi-utility gateway and the orphan smart meter is for its part protected by the secure protocol in order to be communicated to the multi-utility gateway and by the appropriate symmetric key K_DSO in order to be communicated to the orphan smart meter. This symmetric key K_WM can therefore also not be captured by a third-party device. The pairing is thus implemented effectively and securely.

In a particular embodiment, the pairing method comprises:
receiving, in response to the pairing-acceptance message, a pairing-confirmation message, encrypted by means of the second symmetric key K_WM, which includes the identifier information on the relevant information system.

Thus, when the pairing is confirmed by the orphan smart meter, the identifier information on the relevant information system, which was protected by the appropriate symmetric key K_DSO from the relevant information system as far as the orphan smart meter is communicated securely, by means of the symmetric key K_WM henceforth known to the multi-utility gateway and to the orphan smart meter, to the multi-utility gateway.

Another pairing method (matching the pairing method disclosed above) is also proposed here for pairing a smart meter, referred to as an orphan smart meter, with an information system, referred to as the relevant information system, which is intended to remotely manage a subset of smart meters that are registered with said relevant information system, the pairing method being implemented by the orphan smart meter in an automated-management system comprising a plurality of candidate information systems sharing one and the same network infrastructure for remotely managing respective subsets of smart meters, the method comprising:
transmitting, to a multi-utility gateway intended to act as relay between the orphan smart meter and the relevant information system, a pairing request that includes information on the type of smart meter, in clear, and smart-meter identifier information that is in a form encrypted by means of a first symmetric key K_DSO known to the orphan smart meter and to the relevant information system;
receiving, from the multi-utility gateway, a pairing-acceptance message that includes the identifier information on the relevant information system in a form encrypted by means of said first symmetric key K_DSO, as well as a second symmetric key K_WM in a form encrypted by means of a third symmetric key MK_DSO known to the orphan smart meter and to the relevant information system; and
using the multi-utility gateway as intermediary between the orphan smart meter then paired and the relevant information system during subsequent exchanges, using the symmetric key K_WM for communicating with the multi-utility gateway and the first symmetric key K_DSO for communicating with the relevant information system.

In a particular embodiment, this other pairing method comprises:
transmitting, in response to the pairing-acceptance message, a pairing-confirmation message, encrypted by means of the second symmetric key K_WM, which includes the identifier information on the relevant information system.

In a particular embodiment, the pairing methods disclosed above in any one of the embodiments thereof are such that the type of smart meter is among a predefined set of candidate types of smart meter including: electricity meter, water meter and gas meter.

Thus the pairing methods disclosed above in any one of the embodiments thereof are easily applicable to various types of consumption metering while benefiting from one and the same network infrastructure for automated remote management thereof.

A computer program product is also proposed here, comprising instructions for implementing one or other of the pairing methods disclosed above in any one of the embodiments thereof, when the instructions are executed by a processor. An information storage medium is also proposed here, storing instructions for implementing one or other of the pairing methods disclosed above, when the instructions are read from the information storage medium and executed by a processor.

A multi-utility gateway is also proposed here, configured to pair a smart meter, referred to as an orphan smart meter, with an information system, referred to as the relevant information system, which is intended to remotely manage a subset of smart meters that are registered with said relevant information system, the multi-utility gateway being intended to be used in an automated-management system comprising a plurality of candidate information systems sharing one and the same network infrastructure for remotely managing respective subsets of smart meters, the multi-utility gateway comprising electronic circuitry configured to:
receive a pairing request coming from the orphan smart meter, which includes information on the type of smart meter, in clear, and smart-meter identifier information that is in a form encrypted by means of a first symmetric key K_DSO known to the orphan smart meter and to the relevant information system;
find, among the candidate information systems, those that remotely manage smart meters of the same type as the one indicated in the pairing request;
send, by means of a secure protocol via the network infrastructure, to the candidate information systems found, a relayed pairing request that includes said smart-meter identifier information in encrypted form as presented in the pairing request received;
receive, by means of the secure protocol via the network infrastructure, in response to the relayed pairing request, a positive acknowledgement including identifier information on the relevant information system in a form encrypted by means of said first symmetric key K_DSO, a second symmetric key K_WM specific to the orphan smart meter in clear and the same second symmetric key K_WM in a form encrypted by means of a third symmetric key MK_DSO known to the orphan smart meter and to the relevant information system;
transmit to the orphan smart meter a pairing-acceptance message that includes the identifier information on the relevant information system in encrypted form and the second symmetric key K_WM in encrypted form, as presented in the positive acknowledgement received; and
act as intermediary between the orphan smart meter then paired and the relevant information system during subsequent exchanges, using the symmetric key K_WM for communicating with the orphan smart meter then paired.

A smart meter is also proposed here, configured to pair said smart meter, referred to as an orphan smart meter, with an information system, referred to as the relevant information system, which is intended to remotely manage a subset of smart meters that are registered with said relevant information system, the orphan smart meter being intended to be used in an automated-management system comprising a plurality of candidate information systems sharing one and the same network infrastructure for remotely managing respective subsets of smart meters, the orphan smart meter comprising electronic circuitry configured to:
transmit, to a multi-utility gateway intended to act as relay between the orphan smart meter and the relevant information system, a pairing request that includes information on the type of smart meter, in clear, and smart-meter identifier information that is in a form encrypted by means of a first symmetric key K_DSO known to the orphan smart meter and to the relevant information system;
receive, from the multi-utility gateway, a pairing-acceptance message that includes the identifier information on the relevant information system in a form encrypted by means of said first symmetric key K_DSO, as well as a second symmetric key K_WM in a form encrypted by means of a third symmetric key MK_DSO known to the orphan smart meter and to the relevant information system; and
use the multi-utility gateway as intermediary between the orphan smart meter then paired and the relevant information system during subsequent exchanges, using the symmetric key K_WM for communicating with the multi-utility gateway and the first symmetric key K_DSO for communicating with the relevant information system.

A multi-utility system is also proposed here, comprising a multi-utility gateway as disclosed above and a plurality of smart meters as disclosed above, distributed in subgroups that each correspond to installations of one and the same subscriber.

### BRIEF DESCRIPTION OF THE DRAWINGS

The features of the invention mentioned above, as well as others, will emerge more clearly from the reading of the following description of at least one example embodiment, said description being made in relation to the accompanying drawings, among which:

FIG. 1 illustrates schematically an automated smart-meter management system in which the present invention can be implemented;

FIG. 2 illustrates schematically an arrangement of a system grouping together smart meters of the automated smart-meter management system;

FIG. 3 illustrates schematically an example of hardware architecture of a device of the automated-management system; and

FIG. 4 illustrates schematically exchanges occurring in the automated-management system for implementing pairing between a smart meter and an information system that corresponds thereto, to enable the information system in question to collect consumption data from the smart meter in question.

### DETAILED DISCLOSURE OF EMBODIMENTS

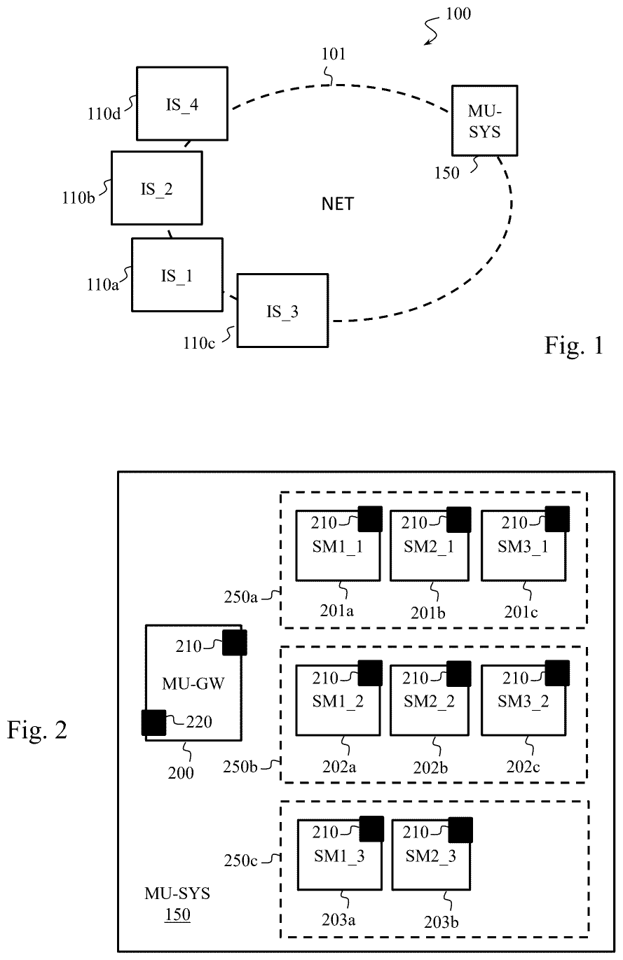

FIG. 1 illustrates schematically an automated-management system (100) in which the present invention can be implemented. The automated-management system 100 is configured to make a collection of consumption data resulting from measurements made by a set of smart meters.

The consumption data collected are processed by several information systems IS that share one and the same network infrastructure NET 101 in order to remotely manage subsets of respective smart meters.

In general terms, the automated-management system 100 comprises a quantity N of information systems IS. For illustration purposes, FIG. 1 presents four information systems IS.

Each information system IS is centralised management equipment dedicated to a said subset of smart meters of the automated-management system 100, which are registered with the information system IS in question, in accordance with subscriptions taken out by respective users (called “subscribers”) with a distributor for which said information system IS operates. For example, a first information system IS_1 110a is dedicated to the processing of consumption data from smart electricity meters on behalf of an electricity distributor A, a second information system IS2 110b is dedicated to the processing of consumption data from smart water meters on behalf of a first water distributor B, a third information system IS3 110c is dedicated to the processing of consumption data from smart gas meters on behalf of a gas distributor C, and a fourth information system IS4 110d is dedicated to the processing of consumption data from smart water meters on behalf of a second water distributor D.

For example, each information system IS comprises various components including a head-end system HES, a meter data management system MDMS, and a key management system KMS. The head-end system HES is configured to implement the management of transmissions in the context of consumption data collection. The meter data management system MDMS is configured to process the consumption data collected. The key management system KMS is configured to store encryption keys necessary for the meter data management system MDMS and for the smart meters that are dependent on the information system IS in question, as well as any intermediate equipment between the information system IS in question and the smart meters in question The components of the information system IS communicate for example using the internet, or more generally a network of the IP (“Internet Protocol”) type, or potentially using a Virtual Private Network VPN.

The automated-management system 100 makes it possible to manage installations, such as blocks of flats or residential units, where various smart meters are colocated. Multi-utility systems MU-SYS 150 are spoken of. The smart meters of these multi-utility systems MU-SYS 150 may be smart meters of various natures (i.e. are adapted to the metering of consumption of distinct energies or fluids). The smart meters of these multi-utility systems MU-SYS 150 may be smart meters of the same nature but on behalf of different distributors (e.g. smart water meters on behalf of the aforementioned first water distributor B and other smart water meters on behalf of the aforementioned second water distributor D).

FIG. 2 illustrates schematically an arrangement of a multi-utility system MU-SYS 150. The multi-utility system MU-SYS 150 is a system grouping together smart meters of the automated-management system 100, typically in a block of flats or a residential unit.

The multi-utility system MU-SYS 150 comprises a multi-utility gateway MU-GW 200 for managing this group of smart meters, and therefore serving as an intermediary between the information systems IS_1 110a, IS_2 110b, IS_3 110c and IS_4 110d on the one hand, and the smart meters of the group on the other hand.

For illustration purposes, the multi-utility system MU-SYS 150 comprises in FIG. 2 a group of eight smart meters. These eight smart meters are in practice distributed in three subgroups 250a, 250b, 250c that each correspond to installations (e.g. premises) of one and the same subscriber. This distribution into subgroups 250a, 250b, 250c is not necessarily known, or useful, from the point of view of the multi-utility gateway MU-GW 200, or of the automated-management system 100 more generally.

Thus, for example, the first subgroup 250a comprises a smart electricity meter SM1_1 201a of a first subscriber, a smart water meter SM2_1 201b of the first subscriber and a smart gas meter SM3_1 201c of the first subscriber. The second subgroup 250b for its part comprises a smart electricity meter SM1_2 202a of a second subscriber, a smart water meter SM2_2 202b of the second subscriber and a smart gas meter SM3_2 202c of the second subscriber. Finally, the third subgroup 250c comprises a smart electricity meter SM3_2 203a of a third subscriber and a smart water meter SM2_3 203b of the third subscriber (no gas meter for this third subscriber).

The presence of the multi-utility gateway MU-GW 200 makes it possible to equip the smart meters of the group with short-range communication means rather than having to equip them with long-range communication means for communicating with the information systems IS_1 110a, IS_2 110b, IS_3 110c and IS_4 110d. The multi-utility gateway MU-GW 200 thus makes it possible to reduce the complexity and the manufacturing cost of smart meters, since short-range communication technologies are typically less complex and expensive than long-range ones.

Thus the smart meters of the group are provided with a short-range communication interface 210. For example, the short-range communication interface 210 is adapted to establish a communication link in accordance with the M-Bus (“Meter Bus”) remote-reading specifications as defined in EN 13757-2 or in accordance with the wM-Bus (“Wireless M-Bus”) specifications as defined in EN 13757-4, with the multi-utility gateway MU-GW 200 (which also has such a short-range communication interface 210). Other short-range communication technologies can be used, such as Wi-Fi, Bluetooth, Zigbee, KNX, KNX-RF, etc.

Furthermore, the multi-utility gateway MU-GW 200 also has a long-range communication means 220 for communicating with the information systems IS_1 110a, IS_2 110b, IS_3 110c and IS_4 110d through the communication network NET 101.

For example, the communication network NET 101 is a wireless communication network of the 5G (5th Generation) type. According to other examples, the communication network NET 101 is a wireless communication network of the following types: GPRS (“General Packet Radio Service”), UMTS (“Universal Mobile Telecommunication System”), LTE-MTC (“Long-Term Evolution Machine Type Communication”), also known by the diminutive LTE-M, or NB-IT (“NarrowBand Internet of Things”).

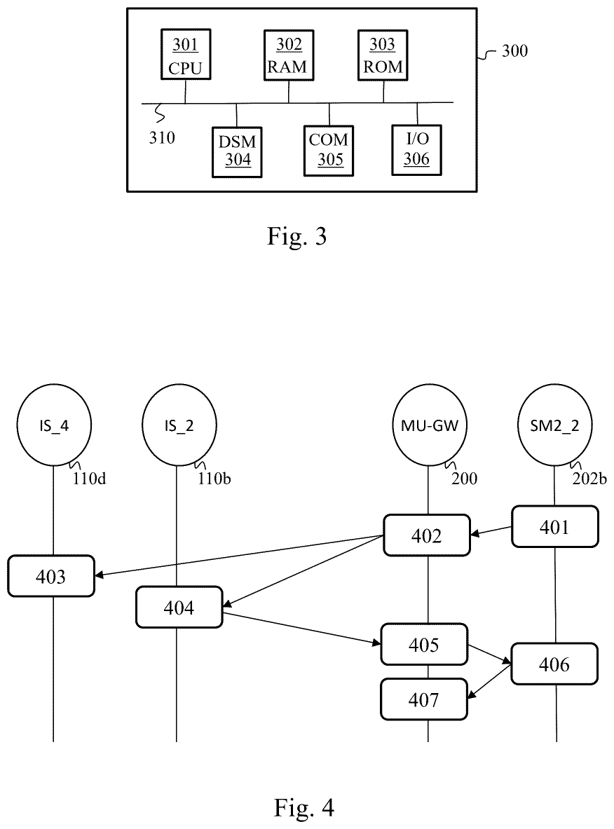

FIG. 3 illustrates schematically an example of hardware architecture 300, which is adapted to implement any device controller of the automated-management system 100. The example of hardware architecture is thus adapted to implement a controller of an information system IS, or of any component of the information system IS. The example of hardware architecture is also adapted to implement a smart-meter controller. The example of hardware architecture is also adapted to implement a controller of a multi-utility gateway MU-GW 200.

The hardware architecture 300 then comprises, connected by a communication bus 310: a processor or CPU (“Central Processing Unit”) 301; a random access memory RAM 302; a read-only memory ROM 303, or EEPROM (“Electrically Erasable Programmable ROM”), or a flash memory; a data storage medium DSM 304, such as a hard disk drive HDD, or a storage medium reader, such as an SD (“Secure Digital”) card reader; and at least one communication interface COM 305. According to the device in question, the hardware architecture 300 may further comprise inputs/outputs I/O 306, for example to make consumption measurements.

The processor 301 is capable of executing instructions loaded in the RAM 302 from the ROM 303, from an external memory (not shown), from a storage medium such as an SD card, or from a communication network. When the hardware architecture 300 is powered up, the processor 301 is capable of reading instructions from the RAM 302 and executing them. These instructions form a computer program causing the implementation, by the processor 301, of the steps and algorithms described here in relation to the device or equipment concerned.

All or some of the steps and algorithms described here can thus be implemented in software form by executing a set of instructions by a programmable machine, such as a DSP (“digital signal processor”) or a microcontroller, or be implemented in hardware form by a machine or a component (“chip”) or a set of components (“chipset”), such as an FPGA (“field-programmable gate array”) or an ASIC (“application-specific integrated circuit”). In general terms, each device or item of equipment of the automated-management system 100 comprises electronic circuitry arranged and configured to implement the steps and algorithms described here in relation to the device or equipment in question.

FIG. 4 illustrates schematically exchanges occurring in the automated-management systems 100 for pairing a smart meter, referred to as an orphan smart meter (i.e. which is not yet paired with an information system IS of the), with the information system IS of the distributor with which the subscription of said smart meter has been taken out, referred to as the relevant information system.

We consider hereinafter, for example, that the pairing relates to the smart water meter SM2_1 201b (orphan smart meter).

In a step 401, the smart water meter SM2_1 201b triggers a pairing request, which causes the sending, by the smart water meter SM2_1 201b to the multi-utility gateway MU-GW 200, of a pairing request.

It is important to note that the smart water meter SM2_1 201b does not know the information system IS to which said smart water meter SM2_1 201b must be attached.

In a particular embodiment, the smart water meter SM2_1 201b has a button, for example on the front face, on which to press (e.g. long pressing with a duration greater than 2 seconds) to trigger a pairing request. The pairing request can in a variant be triggered by selecting an element in a scroll-down menu of a man-machine interface of the smart water meter SM2_1 201b. The pairing request can again in a variant be triggered by receiving an external message or instruction, for example coming from the multi-utility gateway MU-GW 200.

The pairing request is a message that includes:
information on type of message (in clear), which identifies that the message is a pairing request;
information on the type of smart meter (in clear), which identifies of which type of consumption metering is the smart meter that transmits the pairing request from a predefined set of several candidate types of smart meter;
smart-meter identifier information, in encrypted form, which identifies the smart meter in question, this identifier being known to the information system IS on which the smart meter in question is dependent (here the smart water meter SM2_1 201b).

The smart-meter identifier information is for example a serial number of the smart meter in question or information derived from said serial number.

The smart-meter identifier information is preferentially encrypted by means of an asymmetric key K_DSO that is specific to the information system IS on which the smart meter in question depends and is known to the smart meter in question.

The symmetric key K_DSO is for example configured, in the memory of the smart meter in question, when the smart meter in question is installed and the subscription is taken out with the distributor concerned. Subsequently, the symmetric key K_DSO specific to an information system IS_N (with N=1, . . . , 4 in FIG. 1) is called K_DSO[N].

In a particular embodiment, the smart meter in question has another symmetric key MK_DSO, specific to the information system IS on which the smart meter in question is dependent. This symmetric key MK_DSO is called the master key and is used for encrypting other keys. Subsequently, the master key MK_DSO specific to an information system IS_N (with N=1, . . . , 4 in FIG. 1) is called MK_DSO[N].

Unlike the smart-meter identifier information that is present in encrypted form in the pairing request, the smart-meter type information is present therein in clear. The smart-meter type information can thus be captured and used by the multi-utility gateway MU-GW 200.

In the case of the smart water meter SM2_1 201b, the type of smart meter is “water meter”. And the predefined set of candidate types of smart meter is for example: electricity meter, water meter and gas meter. The predefined set of candidate types of smart meter can also include: heat meter. 2 bits thus suffice to code the predefined set of candidate types of smart meter. A different number of bits may be specified, according to the number of candidate types of smart meter to be enabled in the automated-management system 100.

In a step 402, the multi-utility gateway MU-GW 200 receives the pairing request sent by the smart electricity meter SM2_1 201b at the step 401. The multi-utility gateway MU-GW 200 has several candidate information systems for the pairing, namely the information systems IS_1 110a, IS_2 110b, IS_3 110c, IS4 110d. So as to reduce the search for information systems IS to be addressed, the multi-utility gateway MU-GW 200 reads the smart-meter type information included in the pairing request. The multi-utility gateway MU-GW 200 then identifies which are the information systems IS that are intended to manage smart meters that are of the type indicated in the pairing request.

Prior to the on-site installation of the multi-utility gateway MU-GW 200, the information relating to the information systems IS (e.g. electricity distribution, water distribution and gas distribution) with which the meters at the subscribers behind the multi-utility gateway MU-GW 200 are liable to be paired are programmed in said multi-utility gateway MU-GW 200 (in the factory, at the installer or on site, typically).

The multi-utility gateway MU-GW 200 then sends to each of these information systems IS, which were found to be managing smart meters that are of the type indicated in the pairing request (e.g. smart water meters), a relayed pairing request. Said relayed pairing request contains at a minimum the smart-meter identifier information as presented in the pairing request sent by the smart water meter SM2_1 201b (i.e. in encrypted form).

It should be noted that, at this stage, the exchanges between the smart water meter SM2_1 201b and the multi-utility gateway MU-GW 200 are not encrypted. As explained below, the exchanges between each smart meter of the multi-utility system MU-SYS 150 and the multi-utility gateway MU-GW 200 can subsequently, in a particular embodiment, be encrypted by means of a symmetric key K_WM specific to the smart meter in question. Subsequently, the symmetric key K_WM specific to a smart meter SMX_Y (with X=1, . . . , 3 and Y=1, . . . , 3 in FIG. 2) is called K_WM[X_Y].

The exchanges between the multi-utility gateway MU-GW 200 and each of the information systems IS of the automated-management system 100 are implemented by means of a secure protocol, so as to ensure at least the confidentiality of the data exchanged, for example by means of the TLS (“Transport Layer Security”) protocol.

The smart water meter SM2_1 201b being of the “water meter” type, the multi-utility gateway MU-GW 200 generates a relayed pairing request for the attention of the information system IS_2 110b and of the information system IS_4 110d. A multicast transmission can in a variant be used.

We consider, by way of illustration, that the smart water meter SM2_1 201b is supposed to be managed by the information system IS_2 110b (rather than by the information system IS_4 110d).

Therefore, in a step 403, the information system IS_4 110d, in the relayed pairing request that was sent to it, decrypts the smart-meter identifier information. And after decryption by means of the symmetric key K_DSO[4], the information system IS_4 110d does not recognise the smart-meter identifier information as corresponding to a smart-meter identifier that must be attached to it. This is because each information system IS of the automated-management system 100 holds a list of all the identifiers of smart meters of which said information system IS is supposed to have management (i.e. according to the subscriptions taken out with the distributor concerned). Therefore the information system IS_4 110d does not send a response to the multi-utility gateway MU-GW 200 or sends a negative acknowledgement to the relayed pairing request that was sent to it by the multi-utility gateway MU-GW 200.

And, in a step 404, the information system IS_2 110b, in the relayed pairing request that was sent to it, decrypts the smart-meter identifier information. And after decryption by means of the symmetric key K_DSO[2], the information system IS_2 110b recognises the smart-meter identifier information as corresponding to a smart-meter identifier that must be attached to it (i.e. subscription taken out with the distributor concerned). Therefore the information system IS_2 110b responds to the multi-utility gateway MU-GW 200 by a positive acknowledgement to the relayed pairing request that was sent to it by the multi-utility gateway MU-GW 200.

The positive acknowledgement is a message that includes:
information on type of message (in clear), which identifies that the message is a positive acknowledgement to a pairing request;
information on the identifier of the information system IS_2 110b (i.e. the identifier of the information system IS that takes charge of the smart meter for which the pairing was requested), in a form encrypted by means of the symmetric key K_DSO[2];
the symmetric key K_WM[2_1] specific to the smart water meter SM2_1 201b, in clear; and
the same symmetric key K_WM[2_1], encrypted by means of the master key MK_DSO[2].

Other information, intended for the smart water meter 201b, can be included in a form encrypted by means of the symmetric key K_DSO[2] in the positive acknowledgement, such as for example configuration information to be applied by the smart water meter 201b.

Like the rest of the exchanges between the multi-utility gateway MU-GW 200 and the information system IS_2 110b, the positive acknowledgement is transmitted by means of a secure protocol, for example by means of the TLS protocol.

In a step 405, the multi-utility gateway MU-GW 200 reads and stores the symmetric key K_WM[2_1] supplied in clear (after the encryption, for example by means of the TLS protocol, applied in the exchanges between the multi-utility gateway MU-GW 200 and the information system IS_2 110b) in the positive acknowledgement sent by the information system IS_2 110b.

Next, the multi-utility gateway MU-GW 200 generates a pairing-acceptance message intended for the smart water meter SM2_1 201b including the information on the identifier of the information system IS_2 110b, in a form encrypted by means of the symmetric key K_DSO[2], as well as the symmetric key K_WM[2_1] encrypted by means of the master key MK_DSO[2] (i.e. as presented in the positive acknowledgement message sent by the information system IS_2 110b).

Once the pairing-acceptance message has been received, in a step 406, the smart water meter SM2_1 201b can decrypt the symmetric key K_WM[2_1] by means of the master key MK_DSO[2], which makes it possible to subsequently encrypt the exchanges between the smart water meter SM2_1 201b and the multi-utility gateway MU-GW 200. The smart water meter SM2_1 201b can also decrypt the information on the identifier of the information system IS_2 110b, by means of the symmetric key K_DSO[2]. The smart water meter SM2_1 201b is then paired with the information system IS_2 110b.

Then the smart water meter SM2_1 201b sends to the multi-utility gateway MU-GW 200 a pairing-confirmation message, encrypted by means of the symmetric key K_WM[2_1], in which the smart water meter SM2_1 201b sends the information on the identifier of the information system IS_2 110b.

Then, in a step 407, the multi-utility gateway MU-GW 200 stores the information on the identifier of the information system IS_2 110b in association with a descriptor associated with the smart water meter SM2_1 201b, thus noting that the smart water meter SM2_1 201b is attached to and paired with the information system IS_2 110b.

Subsequently, each time a message comes from the smart water meter SM2_1 201b, the multi-utility gateway MU-GW 200 knows which information system IS to address. The multi-utility gateway MU-GW 200 then acts as intermediary between the smart water meter SM2_1 201b (the orphan smart meter then paired) and the information system IS_2 110b (the relevant information system) during subsequent exchanges to enable the information system IS_2 110b, among other operations, to collect consumption data established by the smart water meter SM2_1 201b.

The information exchanged between the smart water meter SM2_1 201b and the information system IS_2 110b (for example metering reading) is encrypted end-to-end with the key K_DSO[2]. The exchanges between the smart water meter SM2_1 201b and the information system IS_2 110b can for example rely on the DLMS/COSEM (“Device Language Message Specification/Companion Specification for Energy Metering”) or LwM2M (“Lightweight Machine to Machine”) protocol.

The multi-utility gateway MU-GW 200 therefore does not have access to this information exchanged between the smart water meter SM2_1 201b and the information system IS_2 110b. And the messages exchanged between the multi-utility gateway MU-GW 200 and the smart water meter SM2_1 201b are encrypted with the symmetric key K_WM[2_1], in order to ensure protection of their contents.

1. A pairing method for pairing a smart meter, referred to as an orphan smart meter, with an information system, referred to as the relevant information system, which is intended to remotely manage a subset of smart meters that are registered with said relevant information system, the pairing method being implemented by a multi-utility gateway in an automated-management system comprising a plurality of candidate information systems sharing one and the same network infrastructure for remotely managing respective subsets of smart meters, the method comprising:
receiving a pairing request coming from the orphan smart meter, which includes information on the type of smart meter, in clear, and smart-meter identifier information that is in a form encrypted by means of a first symmetric key K_DSO known to the orphan smart meter and to the relevant information system;
finding, among the candidate information systems, those that remotely manage smart meters of the same type as the one indicated in the pairing request;
sending, by means of a secure protocol via the network infrastructure, to the candidate information systems found, a relayed pairing request that includes said smart-meter identifier information in encrypted form as presented in the pairing request received;
receiving, by means of the secure protocol via the network infrastructure, in response to the relayed pairing request, a positive acknowledgement including identifier information on the relevant information system in a form encrypted by means of said first symmetric key K_DSO, a second symmetric key K_WM specific to the orphan smart meter in clear and the same second symmetric key K_WM in a form encrypted by means of a third symmetric key MK_DSO known to the orphan smart meter and to the relevant information system;
transmitting to the orphan smart meter a pairing-acceptance message that includes the identifier information on the relevant information system in encrypted form and the second symmetric key K_WM in encrypted form, as presented in the positive acknowledgement received; and
acting as intermediary between the orphan smart meter then paired and the relevant information system during subsequent exchanges, using the symmetric key K_WM for communicating with the orphan smart meter then paired.

2. The pairing method according to claim 1, comprising:
receiving, in response to the pairing-acceptance message, a pairing-confirmation message, encrypted by means of the second symmetric key K_WM, which includes the identifier information on the relevant information system.

3. A pairing method for pairing a smart meter, referred to as an orphan smart meter, with an information system, referred to as the relevant information system, which is intended to remotely manage a subset of smart meters that are registered with said relevant information system, the pairing method being implemented by the orphan smart meter in an automated-management system comprising a plurality of candidate information systems sharing one and the same network infrastructure for remotely managing respective subsets of smart meters, the method comprising:
transmitting, to a multi-utility gateway intended to act as relay between the orphan smart meter and the relevant information system, a pairing request that includes information on the type of smart meter, in clear, and smart-meter identifier information that is in a form encrypted by means of a first symmetric key K_DSO known to the orphan smart meter and to the relevant information system;
receiving, from the multi-utility gateway, a pairing-acceptance message that includes the identifier information on the relevant information system in a form encrypted by means of said first symmetric key K_DSO, as well as a second symmetric key K_WM specific to the orphan smart meter in a form encrypted by means of a third symmetric key MK_DSO known to the orphan smart meter and to the relevant information system; and
using the multi-utility gateway as intermediary between the orphan smart meter then paired and the relevant information system during subsequent exchanges, using the symmetric key K_WM for communicating with the multi-utility gateway and the first symmetric key K_DSO for communicating with the relevant information system.

4. The pairing method according to claim 3, comprising:
transmitting, in response to the pairing-acceptance message, a pairing-confirmation message, encrypted by means of the second symmetric key K_WM, which includes the identifier information on the relevant information system.

5. The pairing method according to claim 1, wherein the type of smart meter is among a predefined set of candidate types of smart meter including: electricity meter, water meter and gas meter.

6. (canceled)

7. A non-transitory information storage medium storing instructions for implementing the pairing method according to claim 1, when the instructions are read from the information storage medium and are executed by a processor.

8. A multi-utility gateway, configured to pair a smart meter, referred to as an orphan smart meter, with an information system, referred to as the relevant information system, which is intended to remotely manage a subset of smart meters that are registered with said relevant information system, the multi-utility gateway being intended to be used in an automated-management system comprising a plurality of candidate information systems sharing one and the same network infrastructure for remotely managing respective subsets of smart meters, the multi-utility gateway comprising electronic circuitry configured to:
receive a pairing request coming from the orphan smart meter, which includes information on the type of smart meter, in clear, and smart-meter identifier information that is in a form encrypted by means of a first symmetric key K_DSO known to the orphan smart meter and to the relevant information system;
find, among the candidate information systems, those that remotely manage smart meters of the same type as the one indicated in the pairing request;
send, by means of a secure protocol via the network infrastructure, to the candidate information systems found, a relayed pairing request that includes said smart-meter identifier information in encrypted form as presented in the pairing request received;
receive by means of the secure protocol via the network infrastructure, in response to the relayed pairing request, a positive acknowledgement including identifier information on the relevant information system in a form encrypted by means of said first symmetric key K_DSO, a second symmetric key K_WM specific to the orphan smart meter in clear and the same second symmetric key K_WM in a form encrypted by means of a third symmetric key MK_DSO known to the orphan smart meter and to the relevant information system;
transmit to the orphan smart meter a pairing-acceptance message that includes the identifier information on the relevant information system in encrypted form and the second symmetric key K_WM in encrypted form, as presented in the positive acknowledgement received; and
acting as intermediary between the orphan smart meter then paired and the relevant information system during subsequent exchanges, using the symmetric key K_WM for communicating with the orphan smart meter then paired.

9. A smart meter configured to pair a smart meter, referred to as an orphan smart meter, with an information system, referred to as the relevant information system, which is intended to remotely manage a subset of smart meters that are registered with said relevant information system, the orphan smart meter being intended to be used in an automated-management system comprising a plurality of candidate information systems sharing one and the same network infrastructure for remotely managing respective subsets of smart meters, the orphan smart meter comprising electronic circuitry configured to:
transmit, to a multi-utility gateway intended to act as relay between the orphan smart meter and the relevant information system, a pairing request that includes information on the type of smart meter, in clear, and smart-meter identifier information that is in a form encrypted by means of a first symmetric key K_DSO known to the orphan smart meter and to the relevant information system;
receive, from the multi-utility gateway, a pairing-acceptance message that includes the identifier information on the relevant information system in a form encrypted by means of the first symmetric key K_DSO, as well as a second symmetric key K_WM specific to the orphan smart meter in a form encrypted by means of a third symmetric key MK_DSO known to the orphan smart meter and to the relevant information system; and
use the multi-utility gateway as intermediary between the orphan smart meter then paired and the relevant information system during subsequent exchanges, using the symmetric key K_WM for communicating with the multi-utility gateway and the first symmetric key K_DSO for communicating with the relevant information system.

10. The multi-utility system comprising a multi-utility gateway according to claim 8 and a plurality of smart meters distributed in subgroups that each correspond to installations of one and the same subscriber, wherein each smart meter is configured to pair an orphan smart meter, with an information system, referred to as the relevant information system, which is intended to remotely manage a subset of smart meters that are registered with said relevant information system, the orphan smart meter being intended to be used in an automated-management system comprising a plurality of candidate information systems sharing one and the same network infrastructure for remotely managing respective subsets of smart meters, the orphan smart meter comprising electronic circuitry configured to:
transmit, to the multi-utility gateway intended to act as relay between the orphan smart meter and the relevant information system, a pairing request that includes information on the type of smart meter, in clear, and smart-meter identifier information that is in a form encrypted by means of a first symmetric key K_DSO known to the orphan smart meter and to the relevant information system;
receive, from the multi-utility gateway, a pairing-acceptance message that includes the identifier information on the relevant information system in a form encrypted by means of the first symmetric key K_DSO, as well as a second symmetric key K_WM specific to the orphan smart meter in a form encrypted by means of a third symmetric key MK_DSO known to the orphan smart meter and to the relevant information system; and
use the multi-utility gateway as intermediary between the orphan smart meter then paired and the relevant information system during subsequent exchanges, using the symmetric key K_WM for communicating with the multi-utility gateway and the first symmetric key K_DSO for communicating with the relevant information system.

11. A non-transitory information storage medium storing instructions for implementing the pairing method according to claim 3, when the instructions are read from the information storage medium and are executed by a processor.
